(19) United States
(12) Patent Application Publication
(10) Pub. No.: US 2003/0056123 A1
(43) Pub. Date: Mar. 20, 2003

(54) Power management method for hand-held information processing apparatus

(76) Inventor: Kuang Hsun Hsieh, Taipei Hsien (TW)

Correspondence Address: Michael D. Bednarek, SHAWPITTMAN, 2300 N. Street, N.W., Washington, DC, 20037, US

(21) Appl. No.: 09/955,034

(22) Filed: Sep. 19, 2001

(51) Int. Cl. G06F 1/26

(52) U.S. Cl. 713/300

(57) ABSTRACT

A power management method for hand-held information processing apparatus includes the steps of creating an idle thread when a central processing unit of the apparatus is in an idle status; counting a number of times of execution of the idle thread; comparing an obtained count with at least a high and a low default; detecting peripherals of the apparatus to see whether they are still in a busy status; temporarily stopping peripherals that are not in the busy status; awaiting until the peripherals that are in the busy status have completed execution of their works; and raising or lowering an execution frequency of a system of the apparatus when the counted number of times of execution of the idle thread is larger than the at least one high default value or smaller than the at least one low default value, respectively.

### BACKGROUND OF THE INVENTION

The present invention relates to a power management method for hand-held information processing apparatus, and more particularly to a power management method adapted to improve the system performance of handheld information processing apparatus.

A central processing unit (CPU) for hand-held information processing apparatus, such as a personal digital assistant (PDA) or a pocket personal computer (PC), typically includes and converts among three working statuses, namely, idle 400, busy 402, and interrupt 404, as shown in FIG. 1. And, all system resources of the hand-held information processing apparatus, including time periods allocated for operating such system resources, a predetermined priority for operating such system resources, etc., are controlled via an operating system (OS) of the apparatus. The CPU is one of these system resources and converts its operation among the idle status 400, the busy status 402, and the interrupt status 404 under the operation of the OS.

FIG. 2 is a block diagram showing a part of components of the OS of the hand-held information processing apparatus. In an operating system using a “thread” as a basic execution unit, there is always a scheduler 54 for scheduling a thread priority, based on which the CPU executes different threads; a dispatcher or dispatch unit 50 that dispatches threads to the CPU for processing; an interrupt handler 52 that executes an interrupt service routine; and a log 60 for storing records about activities executed by the CPU.

A thread is the smallest execution unit that could be dispatched in the system. And, a thread is a program code that may be a kernel code, an operating system code, an application code, or other codes that may be executed over the system. When the CPU is executing threads of different types, the CPU is considered as “busy”.

In the event an interrupt occurs in the system, the interrupt handler 52 included in the operating system will instruct the CPU to execute the interrupt. At this point, the CPU will execute the interrupt service routine. When the interrupt service routine has been executed, the CPU will continue the thread that was previously processed.

When there is not any interrupt to be processed or any thread that is being executed, the CPU is in the idle status. Typically, when the CPU is idle, it repeatedly executes a program code of an idle loop or an idle thread.

In conventional hand-held information processing apparatus, such as the PDA, the pocket PC, etc., the duration of power supply thereof is a very important index of evaluation. As a matter of fact, the system of general hand-held information process apparatus is in a low-operation condition in most time. In other words, the system is not in a full-load condition. However, when viewing from the execution efficiency of the CPU, an execution frequency between the CPU and other peripherals normally has an executing speed in direct proportion to power consumption of the CPU. That is, the conventional hand-held information processing apparatus often consumes extra power due to a processor execution system that has high frequency but low operation performance.

It is therefore tried by the inventor to develop a power management method for hand-held information processing apparatus, so that a large amount of electric energy needed for the apparatus to function normally can be saved without adversely affecting the execution performance of the apparatus.

### SUMMARY OF THE INVENTION

A primary object of the present invention is to provide a power management method for hand-held information processing apparatus, so that a large amount of electric energy needed for the apparatus to function normally can be saved without adversely affecting the execution performance of the apparatus.

To achieve the above and other objects, the power management method of the present invention includes the following steps:

First, a number of times an idle thread has been executed is counted and compared with a default number of times, so as to obtain an output; when the output indicates an execution frequency of a CPU of the apparatus needs to increase, a frequency of the CPU and other peripherals of the apparatus is caused to increase; when the output indicates the execution frequency of the CPU needs to decrease, the frequency of the CPU and the peripherals is caused to decrease; and when the output indicates the execution frequency of the CPU should keep unchanged, the frequency of the CPU and the peripherals is caused to keep unchanged; in the case the frequency of the CPU and the peripherals needs to change, an isolation flag is then set for the peripherals; thereafter, a peripheral busy counter is checked to see whether it is “0”.

When the peripheral busy counter is “0”, a system of the apparatus will directly change the frequency of the CPU and the peripherals and the isolation flag set for the peripherals is canceled.

When the peripheral busy counter is not “0”, the system would detect to see whether it is not within a preset checking time; if not, the peripheral busy counter is checked again to see whether it is “0”; and if yes, the isolation flag set for the peripherals is canceled.

In a first implementation state of the power management for hand-held information processing apparatus of the present invention, the number of times the idle thread has been executed is counted and compared with a default value, which may be set to “5” or other number, depending on an actual implementation condition. In the event the idle thread has already been executed more than the default value of five times in the first implementation state, a frequency-adjusting module in the CPU would set a peripheral isolation flag status register and check a peripheral busy setting register to see whether it has a value of “0”. Suppose the value of the peripheral busy setting register is “2”, that is, among a first, a second, a third, and a fourth peripheral driving device, the second and the fourth peripheral driving devices are inactive while the first and the third peripheral driving devices are active. Under this condition, even the frequency-adjusting module has set the peripheral isolation flag status register to inactivate the first and the third peripheral driving devices in a second implementation state of the power management method, a frequency adjustment for CPU is not carried out until these two active peripheral driving devices have completed their movements.

In a third implementation state of the power management method of the present invention, the first and the third peripheral driving devices have already completed their movements, and the peripheral busy setting register is reset to “0”. At this point, the frequency-adjusting module in the CPU starts lowering the frequency of the CPU. As mentioned above, the power consumption is in direct proportion to the execution frequency. When the execution frequency of the CPU and the peripherals has been lowered, the power consumption of the system of the hand-held information processing apparatus is reduced.

On the contrary, when the number of times the idle thread having been executed is repeatedly counted and compared with a default value, and the counted value is smaller than another low default value, which may be 1 or other number, depending on the actual condition of implementation, and the idle thread has already been executed more than the default value of one time in the first implementation state, the frequency-adjusting module in the CPU would set the peripheral isolation flag status register and verify whether the value of the peripheral busy setting register is “0”. Suppose the value of the peripheral busy setting register is “2” in the first implementation state. That is, among the first, the second, the third, and the fourth peripheral driving devices, the second and the fourth peripheral driving devices are inactive while the first and the third peripheral driving devices are active. Under this condition, even the frequency-adjusting module has set the peripheral isolation flag status register to inactivate the first and the third peripheral driving devices in a second implementation state of the power management method, a frequency adjustment for CPU is not carried out until the two active peripheral driving devices have completed their movements.

In the third implementation state, the first and the third peripheral driving devices have already completed their movements, and the peripheral busy setting register is reset to “0”. At this point, the frequency-adjusting module in the CPU starts raising the frequency of the CPU to restore the execution efficiency of the CPU.

The steps of the power management method for handheld information processing apparatus according to the present invention may be generally summarized as below:

creating an idle thread when the central processing unit of the hand-held information processing apparatus is in an idle status;

counting a number of times the idle thread has been executed;

comparing the counted number of times of execution of the idle thread with at least a high and a low default value; and

raising or lowering an execution frequency of a system of the hand-held information processing apparatus when the counted number of times of execution of the idle thread is larger than the at least one high default value or smaller than the at least one low default value, respectively.

A first sub-step of detecting and verifying whether peripherals of the hand-held information processing apparatus are still in a busy status, and a second sub-step of temporarily stopping the peripherals that are not in the busy status, and awaiting until the peripherals that are in the busy status having completed execution of their respective works may be further provided after the comparing step.

In the power management method of the present invention, the execution frequency of the system is a frequency of the central processing unit and peripheral driving devices of the hand-held information processing apparatus.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows different statuses among which a central processing unit of a hand-held information processing apparatus is converted;

FIG. 2 is a block diagram showing a part of components of an operating system for a hand-held information processing apparatus;

FIG. 3 is a flowchart showing steps included in the power management method of the present invention;

FIG. 4 is a block diagram showing a first implementation state of the power management method of the present invention;

FIG. 5 is a block diagram showing a second implementation state of the power management method of the present invention; and

FIG. 6 is a block diagram showing a third implementation state of the power management method of the present invention.

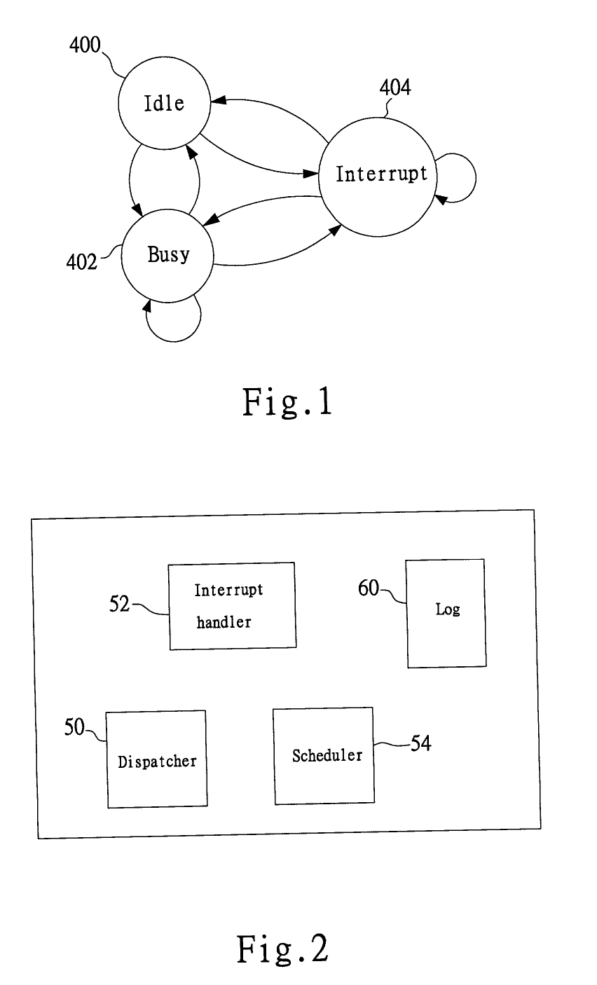

### DETAILED DESCRIPTION OF THE PREFERRED EMBODIMENTS

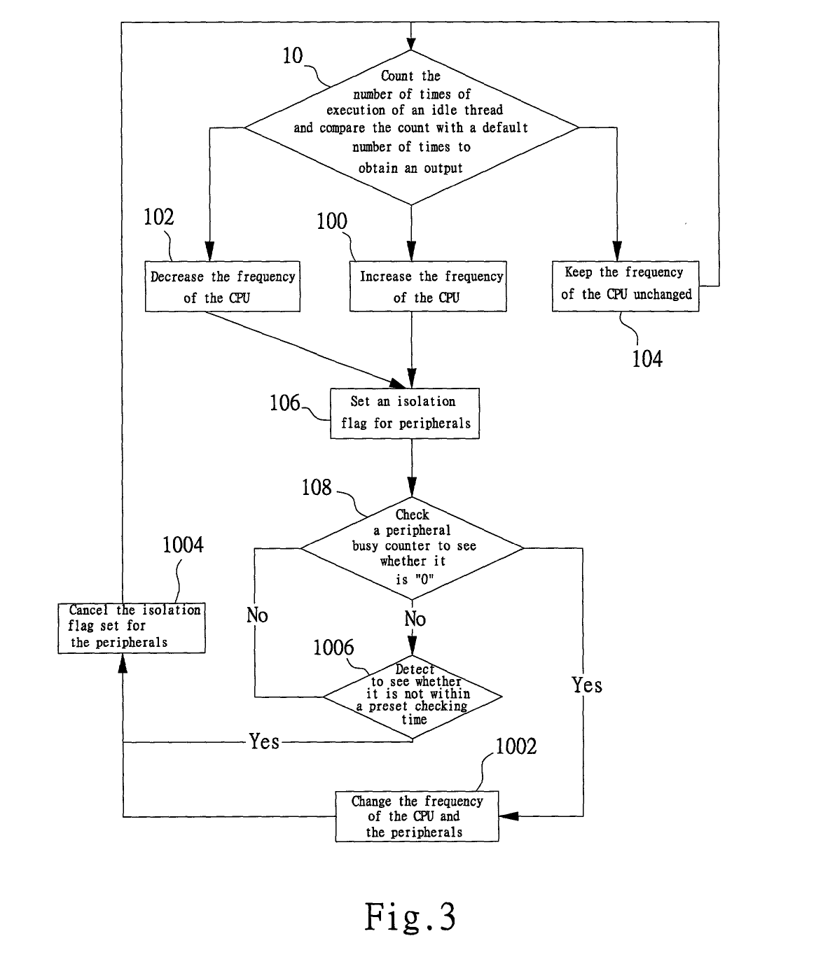

Please refer to FIG. 3 that is a flowchart showing steps included in the power management method for hand-held information processing apparatus according to the present invention. First, a number of times an idle thread has been executed is counted and compared with a default number of times, so as to obtain an output (step 10); when the output from the step 10 indicates an execution frequency of a CPU of the apparatus needs to increase, a frequency of the CPU and other peripherals of the apparatus is caused to increase (step 100); when the output from the step 10 indicates the execution frequency of the CPU needs to decrease, the frequency of the CPU and the peripherals is caused to decrease (step 102); and when the output from the step 10 indicates the execution frequency of the CPU should keep unchanged, the frequency of the CPU and the peripherals is caused to keep unchanged (step 104); in the case the frequency of the CPU and the peripherals needs to change, an isolation flag is then set for the peripherals (step 106); thereafter, a peripheral busy counter is checked to see whether it is “0” (step 108)

When the peripheral busy counter is “0”, a system of the apparatus will directly change the frequency of the CPU and the peripherals (step 1002) and the isolation flag set for the peripherals is canceled (step 1004).

When the peripheral busy counter is not “0”, the system would detect to see whether it is not within a preset checking time (step 1006); if not, the peripheral busy counter is checked again to see whether it is “0” (step 1008); and if yes, the isolation flag set for the peripherals is canceled (step 1004).

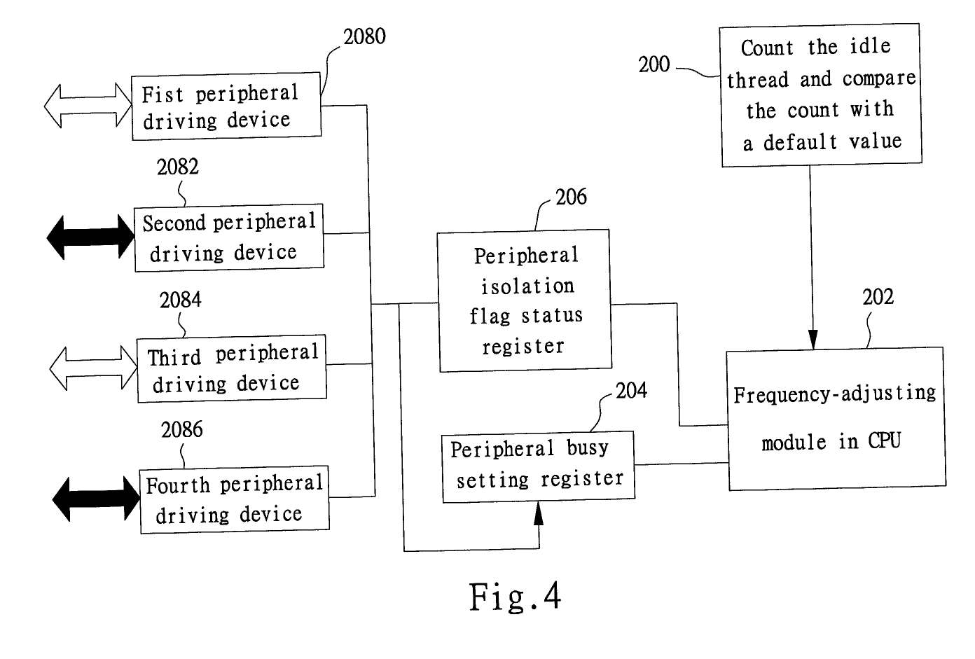

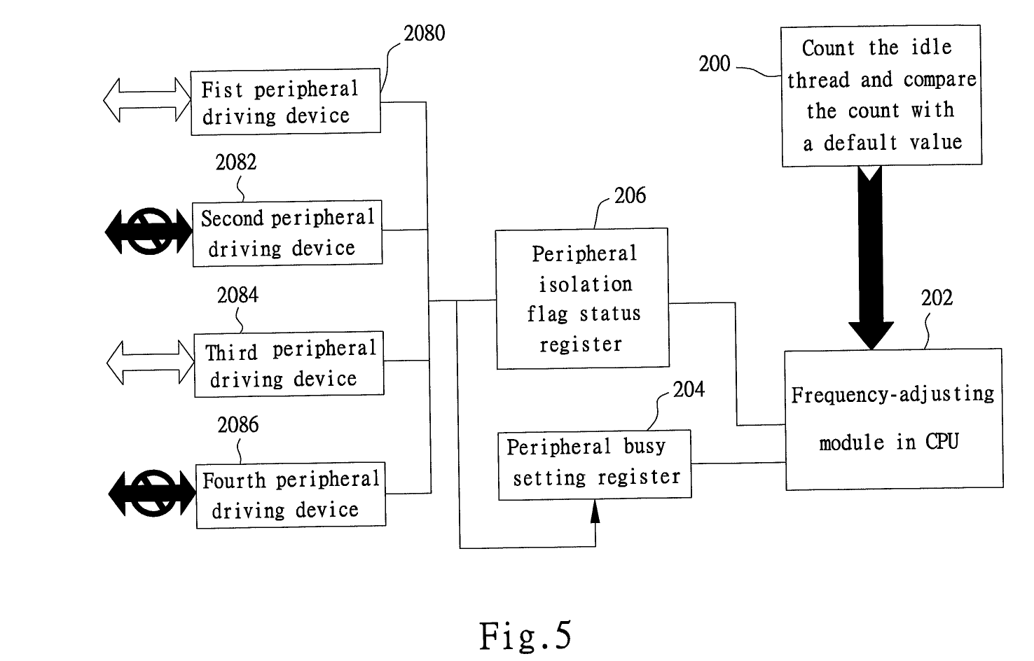

Please refer to FIG. 4 that is a block diagram showing a first implementation state of the power management method of the present invention. In this first implementation state, the number of times the idle thread has been executed is counted and compared with a default value (step 200). The default value may be set to “5” or other number, depending on an actual implementation condition. In the event the idle thread has already been executed more than the default value of five times in the first implementation state, a frequency-adjusting module 202 in the CPU would set a peripheral isolation flag status register 206 and check a peripheral busy setting register 204 to see whether it has a value of “0”. In the illustrated first implementation shown in FIG. 4, the value of the peripheral busy setting register 204 is “2”. That is, among a first peripheral driving device 2080, a second peripheral driving device 2082, a third peripheral driving device 2084, and a fourth peripheral driving device 2086, the second and the fourth peripheral driving devices 2082, 2086 are inactive while the first and the third peripheral driving devices 2080, 2084 are active. Under this condition, even the frequency-adjusting module 202 has set the peripheral isolation flag status register 206 to inactivate the first and the third peripheral driving devices 2080, 2084 (see a second implementation state of the power management method of the present invention shown in FIG. 5), a frequency adjustment for CPU is not carried out until these two peripheral driving devices 2080, 2084 have completed their movements.

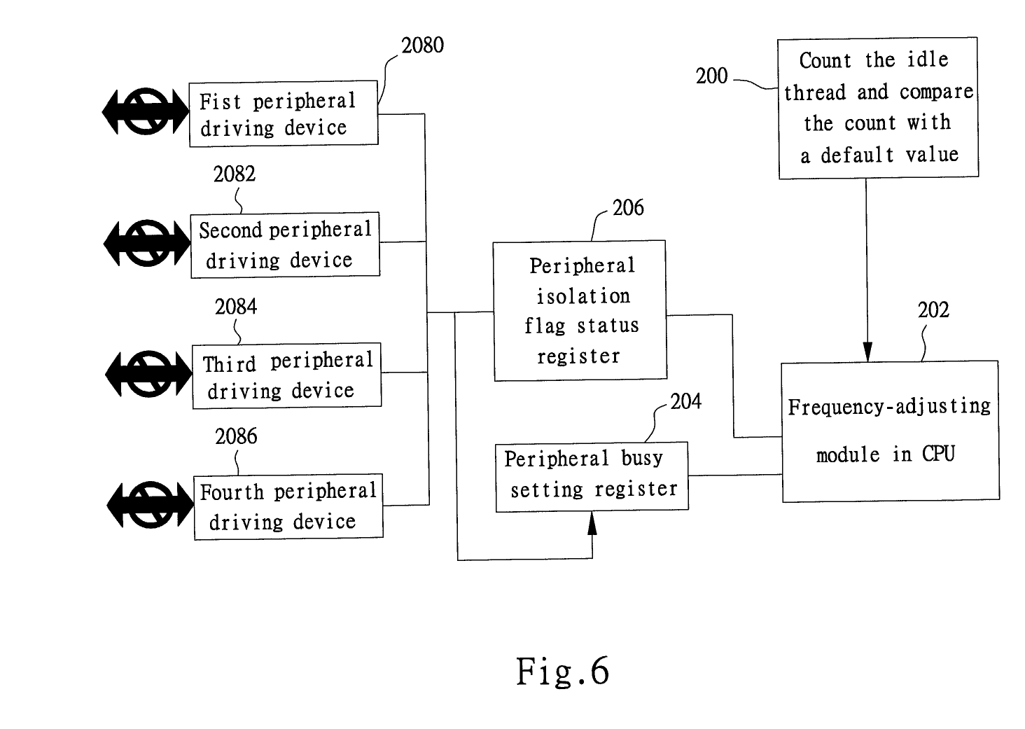

Please now refer to FIG. 6 that is a block diagram showing a third implementation state of the power management method of the present invention. In the third implementation state, the first and the third peripheral driving devices 2080, 2084 have already completed their movements, and the peripheral busy setting register 204 is reset to “0”. At this point, the frequency-adjusting module 202 in the CPU starts lowering the frequency of the CPU. As mentioned above, the power consumption is in direct proportion to the execution frequency. When the execution frequency of the CPU and the peripherals has been lowered, the power consumption of the system of the hand-held information processing apparatus is reduced.

On the contrary, when the number of times the idle thread having been executed is repeatedly counted and compared with a default value (step 200), and the counted value is smaller than another low default value, which may be 1 or other number, depending on the actual condition of implementation, and the idle thread has already been executed more than the default value of one time in the first implementation state, the frequency-adjusting module 202 in the CPU would set the peripheral isolation flag status register 206 and verify whether the value of the peripheral busy setting register 204 is “0”. In the illustrated first implementation shown in FIG. 4, the value of the peripheral busy setting register 204 is “2”. That is, among the first, the second, the third, and the fourth peripheral driving devices 2080, 2082, 2084 and 2086, respectively, the second and the fourth peripheral driving devices 2082, 2086 are inactive while the first and the third peripheral driving devices 2080, 2084 are active. Under this condition, even the frequency-adjusting module 202 has set the peripheral isolation flag status register 206 to inactivate the first and the third peripheral driving devices 2080, 2084 (see the second implementation state of the power management method of the present invention shown in FIG. 5), a frequency adjustment for CPU is not carried out until these two peripheral driving devices 2080, 2084 have completed their movements.

Please now refer to the third implementation state of the power management method of the present invention shown in FIG. 6 again. In the third implementation state, the first and the third peripheral driving devices 2080, 2084 have already completed their movements, and the peripheral busy setting register 204 is reset to “0”. At this point, the frequency-adjusting module 202 in the CPU starts raising the frequency of the CPU to restore the execution efficiency of the CPU.

From the above description, it is understood the power management method for hand-held information processing apparatus according to the present invention allows the system of the apparatus to maintain effective execution efficiency.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A power management method for hand-held information processing apparatus, comprising the following steps:
creating an idle thread when a central processing unit of said hand-held information processing apparatus is in an idle status;
counting a number of times said idle thread has been executed;
comparing said counted number of times of execution of said idle thread with at least a high and a low default value; and
raising or lowering an execution frequency of a system of said hand-held information processing apparatus when said counted number of times of execution of said idle thread is larger than said at least one high default value or smaller than said at least one low default value, respectively.

2. A power management method for hand-held information processing apparatus, comprising the following steps:
creating an idle thread when a central processing unit of said hand-held information processing apparatus is in an idle status;
counting a number of times said idle thread has been executed;
comparing said counted number of times of execution of said idle thread with at least a high and a low default value;
detecting and verifying whether peripherals of said hand-held information processing apparatus are still in a busy status;
temporarily stopping said peripherals that are not in said busy status, and awaiting until said peripherals that are in said busy status having completed execution of their respective works; and
raising or lowering an execution frequency of a system of said hand-held information processing apparatus when said counted number of times of execution of said idle thread is larger than said at least one high default value or smaller than said at least one low default value, respectively.

3. The power management method as claimed in claim 1, wherein said execution frequency of said system is a frequency of said central processing unit and peripheral driving devices of said hand-held information processing apparatus.

4. The power management method as claimed in claim 2, wherein said execution frequency of said system is a frequency of said central processing unit and peripheral driving devices of said hand-held information processing apparatus.
